(19) United States
(12) Patent Application Publication
(10) Pub. No.: US 2014/0019227 A1
(43) Pub. Date: Jan. 16, 2014

(54) DETERMINING THE EFFECTIVENESS OF ADVERTISING

(71) Applicants: Jason Paul DeMont, McKinney, TX (US); James A. Walker, Freehold, NJ (US)

(72) Inventors: James A. Walker, Freehold, NJ (US); Jason Paul DeMont, McKinney, TX (US)

(21) Appl. No.: 13/938,991

(22) Filed: Jul. 10, 2013

Related U.S. Application Data
(60) Provisional application No. 61/669,865, filed on Jul. 10, 2012.

(51) Int. Cl. G06Q 30/02

(52) U.S. Cl. CPC G06Q 30/0244
USPC 705/14.43; 705/14.64; 705/14.45

(57) ABSTRACT

A user carries a wireless telecommunications terminal, such as a cell phone, smart phone, tablet, and the like. The wireless telecommunications terminal—alone or in conjunction with the wireless telecommunications infrastructure—records the movement of the user. In other words, the wireless terminal records when and where the user has been. This information is uploaded to a database in well-known fashion. The database contains similar information for many other users. In some embodiments, of the present invention, the wireless terminal is assigned an anonymous user ID that can be reconciled with a specific user if that user then calls in using the wireless terminal.

### CROSS REFERENCE TO RELATED APPLICATIONS

moon This case claims priority to U.S. Provisional Patent Application Ser. No. 61/669,865, filed Jul. 10, 2012 (Attorney Docket: 107-121us), which is incorporated by reference herein.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to advertising in general, and, more particularly, to techniques for choosing an advertising form.

### BACKGROUND OF THE INVENTION

Advertising exists in many forms: radio, television, newspapers, magazines, Internet-based, billboards, direct mail, etc.

When an advertiser considers whether to use a particular form of advertising, the advertiser wants to understand the effectiveness and efficiency of that form. Typically, however, it is difficult for an advertiser to understand the effectiveness and efficiency of most forms of advertising because it is difficult to correlate the exposure of consumers to an advertisement and the purchases made as a result of that exposure.

There are techniques in the prior art that are used by advertisers to correlate the exposure of consumers to an advertisement and purchases made as a result of that exposure. In accordance with one class of techniques, an advertiser entices the consumer to provide direct evidence of the exposure of the consumer to the advertisement when purchasing the product. For example, the advertiser can print a coupon that the consumer can redeem for a discount when buying the product. The purchase of the product in conjunction with the redemption of the coupon provide evidence of the correlation between the advertisement and the purchase.

Additionally, the advertiser can incorporate an indication of the advertisement into the address for contacting the advertiser. For example, an advertiser who presents a television infomercial on WNBC television might direct consumers to call 1-800-555-WNBC, whereas when the same infomercial on KFOX television might direct consumers to call 1-800-555-KFOX.

### SUMMARY OF THE INVENTION

Advertising can be classified as either “directed” or “undirected.” In directed advertising, an advertisement is directed to a specific individual. Examples of directed advertising include, for example and without limitation, a direct mailing to a specific individual, a Web-based ad that is delivered to a specific device, etc. The content of the advertisement might or might not be tailored to the individual.

Undirected advertising, in contrast, is not directed to a specific individual. Examples of indirect advertising include, for example and without limitation, highway billboards, aerial banners, and television ads. Further, the content of undirected advertising is not tailored to an individual.

Advertising can also be classified as either “line-of-sight” or “non-line-of-sight.” Exposure to line-of-sight advertising requires the consumer to be within the line-of-sight of the advertisement. Examples of line-of-sight advertising include, for example and without limitation, a highway billboard, an aerial banner, etc.

Example of non-line-of-sight advertising include, for example and without limitation, television and radio ads because the consumer can be out-of-sight of the source of the advertisement (e.g., the television station, the radio station, etc.).

In some embodiments of the present invention, a user carries a wireless telecommunications terminal, such as a cell phone, smart phone, tablet, and the like. The wireless telecommunications terminal—alone or in conjunction with the wireless telecommunications infrastructure—records the movement of the user. In other words, the wireless terminal records when and where the user has been. This information is uploaded to a database in well-known fashion. The database contains similar information for many other users. In some embodiments, of the present invention, the wireless terminal is assigned an anonymous user ID that can be reconciled with a specific user if that user then calls in using the wireless terminal.

In some embodiments of the present invention, a wireless terminal is uniquely identified with a user's computer. This one-to-one correspondence can be established based on wireless terminal control software currently used to manage wireless terminals, such as iTunes, etc. By linking the identities of a user's wireless terminal and the user's computer, the movements of the wireless terminal can be associated with cookies and/or digital fingerprints stored on that computer—thereby providing a richer data set to an advertiser.

In some embodiments, a geo-temporal correlation of when and where one or more users have been with respect to when and where the advertiser has advertised is developed. In some embodiments, an indicator of the effectiveness and efficiency of one or more advertising media and/or advertising locations is developed based on the geo-temporal correlation.

In some embodiments of the present invention, the content of an electronic billboard is controlled is based on the geo-temporal correlation.

In some embodiments of the present invention, both tracking (data collection and model informing) and targeting (show messages relevant to that user) is performed based on the geo-temporal correlation.

Some embodiments of the present invention enable a static billboard to display targeted advertising to a plurality of users, wherein the displayed content is based on the estimated value of each of the plurality of users. In some embodiments, the displayed information is based on an algorithm, wherein the estimated value of each of the plurality of users is a weighted input to the algorithm. In some embodiments, the estimated value of each of the plurality of consumers is based on one or more of: (1) a record of the inquiries and orders for products and services from each user; (2) each users' computer accounts; (3) each users' banking and credit card records; (4) customer databases that contain some or all records of each user's interaction with the brand; (5) the lifetime value of each user; (6) and commercial data sources.

An embodiment of the present invention comprises a system comprising: a wireless telecommunications terminal; a location engine for determining the location of the wireless terminal at a plurality of times; a database for storing information regarding the location of advertising; and a processor for correlating the location of the wireless terminal with the location of the advertising.

### BRIEF DESCRIPTION OF THE DRAWINGS

FIG. 1 depicts a schematic diagram of a geo-temporal advertising system in accordance with an illustrative embodiment of the present invention.

FIG. 2 depicts operations of a method for developing an assessment of the effectiveness of advertising.

FIG. 3 depicts operations of a method for using system 100 to control content 114 based on a plurality of users within viewing field 112.

### DETAILED DESCRIPTION

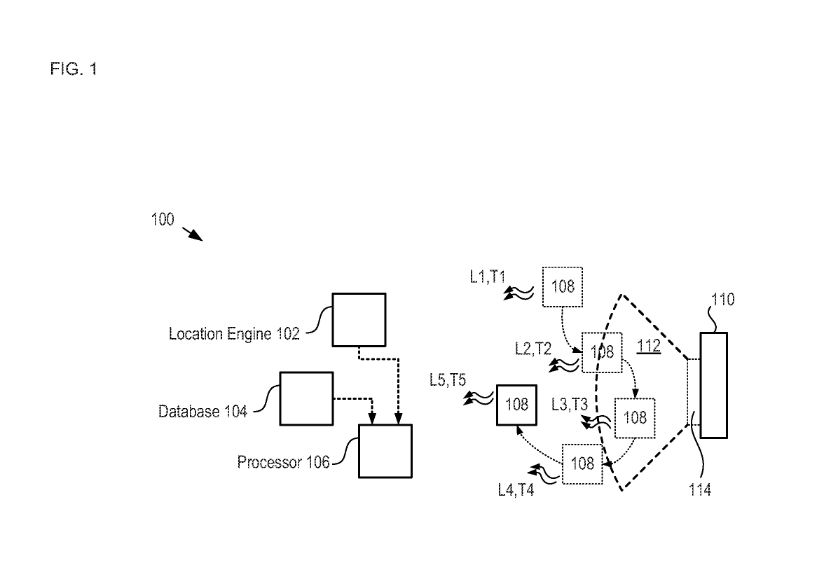

FIG. 1 depicts a schematic diagram of a geo-temporal advertising system in accordance with an illustrative embodiment of the present invention. System 100 comprises location engine 102, database 104, and processor 106. System 100 is operative for determining when and where the proximity between a user and an advertisement has been sufficient to enable the user to have been exposed to the advertisement.

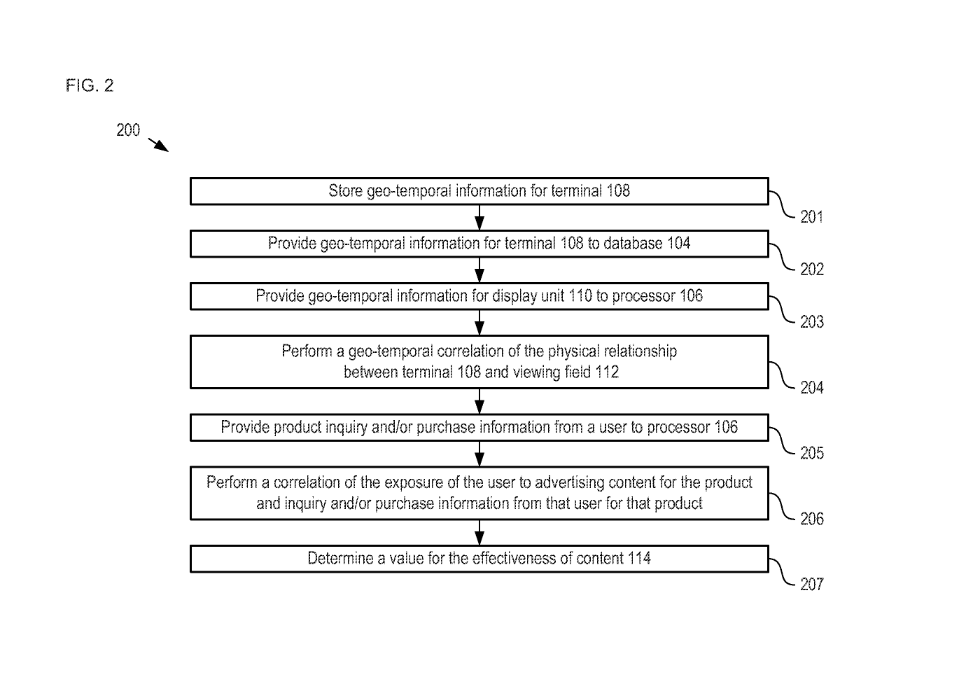

FIG. 2 depicts operations of a method for developing an assessment of the effectiveness of advertising. Method 200 begins with operation 201, wherein geo-temporal information for wireless telecommunications terminal 108 (hereafter referred to as “terminal 108”) is stored.

Terminal 108 is a conventional wireless device carried by a user. Examples of wireless devices suitable for use as terminal 108 include, without limitation, cellular telephones, smart phones, tablet computers, and the like. Terminal 108, alone or in conjunction with the wireless telecommunications infrastructure, records when and where the terminal has been. This geo-temporal information includes a plurality of locations, L, and the time, T, at which the terminal was at each of the plurality of locations. This information is denoted for five sequential locations of terminal 108 as L1,T1 through L5,T5.

At operation 202, the geo-temporal information stored by terminal 108 is uploaded to database 104 in conventional fashion. In some embodiments, this information is uploaded to database 104 directly from wireless telecommunication device 108 (i.e., through a wireless telecommunications network). In some embodiments, database 106 receives the geo-temporal information from wireless telecommunication device 108 indirectly, such as through a computer terminal associated with wireless telecommunications device 108, an intermediary application (e.g., Facebook, etc.) a gps mobile navigation program, google maps, etc.

In some embodiments of the present invention, terminal 108 is assigned an anonymous user ID that can be reconciled with a specific user if that user then contacts the advertiser or visits its website using the wireless terminal.

In some embodiments of the present invention, a wireless terminal is uniquely identified with a user's computer. This one-to-one correspondence can be established based on wireless terminal control software currently used to manage wireless terminals, such as iTunes, etc. By linking the identities of a user's wireless terminal and the user's computer, the movements of the wireless terminal can be associated with cookies and/or digital fingerprints stored on that computer—thereby providing a richer data set to an advertiser.

At operation 203, database 104 provides geo-temporal information for advertising display unit 110 (hereinafter referred to as “display unit 110”) to processor 106.

Processor 106 is a conventional processor that is operative for correlating geo-temporal information for one or more terminals with the geo-temporal information for one or more advertising display units. In some embodiments, processor 106 is also operative for correlating the purchases of one or more products or services with a correlation between the location of a wireless terminal and the location of advertising of the products or services.

Display unit 110 is a conventional immovable electronic billboard that displays content 114, which is observable anywhere within viewing field 112. Content 114 changes periodically to sequentially display advertisements for different products. As a result, the product being advertised via content 114 is a function of time. In some embodiments of the present invention, display unit 110 is other than an electronic billboard. Examples of display units suitable for use with the present invention include, without limitation, conventional immovable static-display billboards, other stationary displays that sequentially display a plurality of advertisement content 114 (e.g., scrolling advertising displays, such as those situated near sporting events, stadium scoreboards, conferences, projection displays, etc.), moving displays, such as busses, taxis, advertising trucks, commuter trains, subway cars, aerial displays (e.g., blimps, banners towed by airplanes, etc.) and the like, and combinations of the above.

It should be noted that the size and shape of viewing field 112 is based on the type of display unit being used. For example, for a display unit such as a blimp, the viewing field is much larger than that of a billboard and approximates a circular or elliptical region that substantially surrounds the location of the blimp.

Embodiments of the present invention enable correlations based on:
i) static users; or
ii) moving users; or
iii) static displays; or
iv) moving displays; or
v) displays having fixed advertising content; or
vi) displays having non-fixed advertising content; or
iv) any combination of I, ii, iii, iv, v, and vi.

It will be clear to one skilled in the art, after reading this Specification, how to specify, make, and use embodiments of the present invention wherein correlation can be determined based on any change in the relative position between a display unit and a user and/or the time at which a user is within viewing area 112 and what is provided as content 114 during that time.

Database 104 is a conventional database that stores information about one or more advertising display units, as well as information about one or more users whose locations can be correlated to the location of the advertising display unit or units. Information stored in database 104 includes a variety of information, such as:
i) geo-temporal information; or
ii) viewing field 112 size and shape; or
iii) temporal content information; or
iv) records of inquiries and orders for products and services from a user associated with terminal 108; or
v) estimated user value; or
vi) estimated user lifetime value; or
iv) any combination of I, ii, iii, iv, v, and vi.

At operation 204, processor 106 performs a geo-temporal correlation of when and where the terminal 108 has been with respect to viewing field 112 and content 114. For example, as depicted in FIG. 1, processor 106 determines that from time T2 to time T4, terminal 108 was located within viewing field 112 and viewed the content displayed during that time period.

At operation 205, inquiry and/or purchasing information for a product from a user relative to the advertising for that product provided at display unit 110 is provided to processor 106. In some embodiments, the record of the inquiries and orders for products and services from a user is collected from one or more of the wireless terminal itself, the users' computer accounts, and the users' banking and credit card records. Customer databases often contain all records of a customer's interaction with the brand along with measures of parameters like “lifetime value”. Users are also often mapped to commercial data sources, such as Nielsen data, Exelate, Experian, and others that are used for modeling purposes for prospect list creation.

At operation 206, processor 106 performs a correlation between exposure of the user of terminal 108 to content 114 and inquiry and/or purchasing information for the product advertised by content 114.

At operation 207, processor 106 determines a value for the effectiveness of advertising content provided at display unit 110.

The value for the effectiveness of advertising for a product is based on the inquiry and/or purchasing information provided to processor at operation 205, as well as the geo-temporal correlation of when and where the terminal 108 has been with respect to viewing field 112 determined at operation 204. By correlating product inquiries/purchases by a user with when and where the user was exposed to advertisement for that product, the advertiser can better judge the effectiveness and efficiency of its advertising. This is particularly useful for static, geographically-limited advertising such as billboards, stadium displays (e.g., scoreboard ads, mezzanine ring displays, electronic billboards, scrolling billboards, etc.), or moving advertising such as blimps, busses, taxis, and the like.

For example, if an advertiser has two billboards on a highway. One is in town A and the other is five miles away in town B. Some embodiments of the present invention enable the advertiser to determine whether the user had been exposed to either billboard before ordering the product. Furthermore, some embodiments of the present invention enable the advertiser to determine whether the user has been exposed to both billboards and in which order before ordering the product. And still furthermore, some embodiments of the present invention enable the advertiser to determine how long the interval was between when the user was exposed to the billboards (or combinations of ad media, such as a billboard and an online ad, etc.) before ordering the product.

One application of this geo-spatial linking is to enable a quantitative assessment of the effectiveness of an advertising campaign paid for by the producer of a service or product. For example, typically, a producing company will contract with an advertising company to produce a multi-media campaign to promote their product. To date, however, the only metric available to the producing company has been a change in the sales of that product. Since sales volume can be affected by many factors (e.g., seasons, weather, local or global economy, etc.), the advertising company has little opportunity to directly demonstrate the effectiveness of their campaign. The present invention, however, provides the advertising company with a verifiable number of instances that specific users have been exposed to advertising content of their campaign. By providing a link between those instances and product inquiries and/or purchases by those specific users, the advertising company can provide the producing company with quantitative results that are tightly correlated to the advertising campaign itself.

A second application of this geo-spatial linking is to determine the best mix of media (media-mix-modeling) for driving engagement with a brand. For example, by enabling determination of the number of billboard ads, direct mail pieces and online ads a user has been exposed to before they made their inquiry or purchase, an advertiser can determine the cost to acquire that particular customer or a segment of customers with similar ad exposure. The advertiser can then optimize their marketing budgets accordingly.

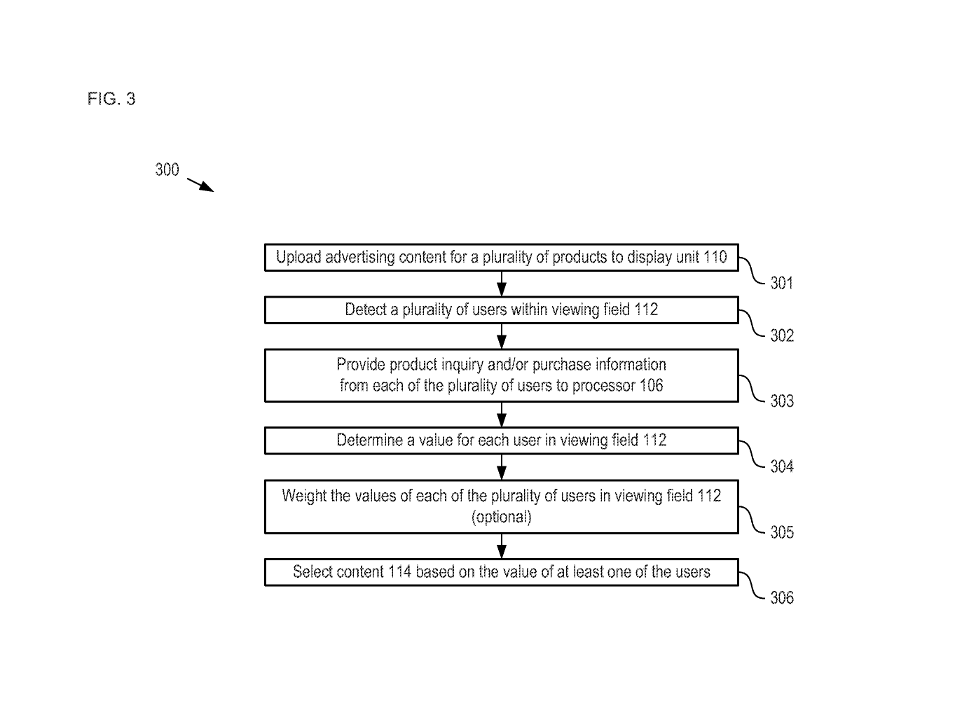

FIG. 3 depicts operations of a method for using system 100 to control content 114 based on a plurality of users within viewing field 112. Method 300 begins with operation 301 where advertising content for a plurality of products is uploaded to display unit 110.

At operation 302, a plurality of users within viewing field 112 is detected.

At operation 303, inquiry and/or purchasing information for each of the plurality of products for each user correlated to terminals 108-1 through 108-N, where N is the total number of users detected in viewing field 112, is provided to processor 106.

At operation 304, a value is determined for each user within viewing field 112.

At operation 305, the product advertised in content 114 is selected based on the value of at least one of the users within viewing field 112. In some embodiments, content 114 is selected based on a weighting algorithm that assigns a weight to each of the values of the users.

In some embodiments, content 114 is selected to provide a specific message based on what message a user has been previously shown in order to keep the communication consistent or fresh or to only show promotions local to a user even if they're out of their normal geography. Some embodiments of the present invention can enable both tracking (data collection and model informing) and targeting (show messages relevant to that user).

It should be noted that prior-art ad targeting (e.g., Foursquare) enables a user to see specials and promotions from a restaurant once the user has “checked in.” This requires active participation by the user, however. Some embodiments of the present invention enable advertisers to target a user device so that the user passively receives advertising based solely on their geo-location.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A system comprising:
a location engine that is operative for determining geo-temporal information for a first wireless telecommunications terminal, the geo-temporal information including the location of the first wireless telecommunications terminal at a plurality of times;
a database that is operative for storing information regarding the location of advertising; and
a processor that is operative for correlating the geo-temporal information for the first wireless terminal with the location of the advertising.

2. The system of claim 1 further comprising:
a computer associated with the first wireless telecommunications terminal for accessing advertising and buying products and services; and
wherein the processor is also operative for correlating the buying of products and services with the geo-temporal information for the first wireless telecommunications terminal and the location of the advertising.

3. The system of claim 1 wherein the processor is also operative for establishing a one-to-one correspondence of a first user and the first wireless telecommunications terminal.

4. The system of claim 3 wherein the processor is also operative for correlating the buying of products and services by the first user with the geo-temporal information for the first wireless telecommunications terminal and the location of the advertising.

5. The system of claim 4 wherein the processor is also operative for controlling the content displayed by an advertising display unit based on a correlation between the buying of products and services by the first user and the location of the advertising display unit.

6. The system of claim 4 wherein the processor is also operative for assigning a first value to the first user, the first value being based on a history of buying of products and services by the first user.

7. The system of claim 1 wherein the processor is also operative for establishing a one-to-one correspondence between each of a plurality of users and each of a plurality of wireless telecommunications terminals, the plurality of users including the first user and the plurality of wireless telecommunications terminals including the first wireless telecommunications terminal, and wherein the location engine is also operative for determining geo-temporal information for each of the plurality of wireless telecommunications terminals, the geo-temporal information including the location of each wireless telecommunications terminal at a plurality of times.

8. The system of claim 7 wherein the processor is also operative for:
assigning a value to each of the plurality of users, each value being based on a history of buying of products and services by its respective user; and
controlling the content displayed by an advertising display unit based on the plurality of values.

9. The system of claim 8 wherein the processor is also operative for establishing a weighted algorithm for selecting the content, wherein each of the plurality of values is assigned a weight.

10. The system of claim 1 wherein the database is also operative for storing information regarding the time-dependent content of the advertising.

11. The system of claim 10 wherein the processor is also operative for correlating the geo-temporal information for the first wireless telecommunications terminal and the time-dependent content.

12. A method comprising:
determining geo-temporal information for a first wireless telecommunications terminal, the geo-temporal information including the location of the first wireless telecommunications terminal at a plurality of times; and
correlating the location of the first wireless telecommunications terminal with the location of advertising.

13. The method of claim 12 further comprising correlating geo-temporal information of the first wireless telecommunications terminal and time-dependent content of the advertising.

14. The method of claim 12 further comprising:
establishing a one-to-one correspondence of a first user and the first wireless telecommunications terminal; and
establishing a value for the user, the value being based on a history of buying of products and services by the first user.

15. The system of claim 12 further comprising correlating the buying of products and services with the geo-temporal information for the first wireless telecommunications terminal and the location of the advertising.

16. The system of claim 15 wherein the first wireless telecommunications terminal is associated with a first computer, and wherein the first computer is operative for accessing advertising and buying products and services.

17. The system of claim 12 further comprising:
determining geo-temporal information for a plurality of wireless telecommunications terminals that includes the first wireless telecommunications terminal, the geo-temporal information including the location of each wireless telecommunications terminal at a plurality of times; and
correlating the location of the plurality of wireless telecommunications terminals with the location of advertising.

18. The method of claim 17 further comprising:
establishing a one-to-one correspondence for a plurality of users and each of the plurality of wireless telecommunications terminals;
establishing a value for each of the plurality of users, the value being based on a history of buying of products and services by its respective user; and
controlling the content displayed by an advertising display unit based on the plurality of values.

19. The system of claim 18 further comprising establishing a weighted algorithm for selecting the content, wherein each of the plurality of values is assigned a weight.
